(19) United States
(12) Patent Application Publication
(10) Pub. No.: US 2008/0075321 A1
(43) Pub. Date: Mar. 27, 2008

(54) IMAGING DIAGNOSIS SYSTEM AND ITS OPERATIONAL APPARATUS

(76) Inventor: Hiroyuki Kabasawa, Tokyo (JP)

Correspondence Address: Patrick W. Rasche;Armstrong Teasdale LLP, Suite 2600, One Metropolitan Square, St. Louis, MO, 63102, US

(21) Appl. No.: 11/857,259

(22) Filed: Sep. 18, 2007

(30) Foreign Application Priority Data
Sep. 21, 2006 (JP) 2006-256001

(51) Int. Cl. G06K 9/00

(52) U.S. Cl. 382/100

(57) ABSTRACT

The display unit displays a plurality of inspection attributes differently in appearance, depending on the activity ratio of each of the inspection attributes calculated by an inspection activity ratio calculation device. For example, the display unit displays character strings corresponding to the plurality of inspection attributes in different font sizes or different colors, depending on the activity ratio of each inspection attribute calculated by the inspection activity ratio calculation device.

### BACKGROUND OF THE INVENTION

The present invention relates to an imaging diagnosis system and its operational apparatus. In particular, the invention relates to an imaging diagnosis system and its operational apparatus that capture images of a subject within an imaging region by displaying a plurality of inspection attributes for capturing images of an subject within an imaging region, selecting some inspection attributes from the displayed plurality of inspection items, and carrying out an inspection protocol set to involve the selected inspection attributes.

An imaging diagnosis system including an imaging apparatus such as a magnetic resonance imaging (MRI) apparatus is know as a system that captures a diagnostic image such as a slice image of a cross section of a subject.

For example, when a slice image is captured using the magnetic resonance imaging apparatus, an imaging region of a subject is first positioned in a space where a static magnetic field is formed and the direction of spin of protons within the imaging region is made aligned with the direction of the static magnetic field, so that the protons have magnetization vectors. Then, by irradiation of electromagnetic waves with a resonant frequency from an RF coil, nuclear magnetic resonance is introduced and the magnetization vectors of the protons are changed. The magnetic resonance imaging apparatus receives magnetic resonance signals from the protons reverting to the previous magnetization vectors by the RF coil and creates a slice image, based on the received magnetic resonance signals.

Such an imaging diagnosis system is operated by an operational device. The operational device is, for example, a graphical user interface (GUI). Upon a request from a section in a hospital, when an operator such as an inspecting engineer manually operates the GUI, an imaging protocol is called and a plurality of inspection attributes selectable by the operator are displayed on a display screen. The operator selects inspection attributes to be executed from the plurality of inspection attributes displayed on the display screen and inputs a command corresponding to the selection. After that, according to the input command, the imaging protocol is set and executed (e.g., refer to Patent Document 1).

[Patent Document 1] Japanese Published Unexamined Patent Application No. 2002-165775

In such an operational device, however, because a plurality of inspection attributes are displayed on the display screen and a command selected by the operator has to be input for each of the plurality of inspection attributes, it might be difficult to carry out inspection efficiently. For example, if the operator is unskilled, it would take time to make a decision and perform input operation when selecting inspection attributes to be executed and, therefore, the efficiency of imaging operation when capturing images of a subject might decrease.

In the case of magnetic resonance imaging apparatus, there are many inspection attributes that complicate its operation and, consequently, the above problem often emerges.

### SUMMARY OF THE INVENTION

It is desirable that the problem described previously is solved.

One aspect of the invention resides in an imaging diagnosis system comprising a display unit displaying a plurality of inspection attributes for capturing images of a subject within an imaging region, a selection unit selecting some inspection attributes from said plurality of inspection attributes displayed on said display unit, and an image capturing unit capturing the images within said imaging region in accordance with the inspection attributes selected by said selection unit, the imaging diagnosis system including an inspection activity ratio calculation unit for calculating an activity ratio of each of the inspection attributes selected by said selection unit from said plurality of inspection attributes, said display unit displaying said plurality of inspection attributes differently in appearance, depending on the activity ratio of each inspection attribute calculated by said inspection activity ratio calculation unit.

Another aspect of the invention resides in an operational apparatus comprising a display unit displaying a plurality of inspection attributes for capturing images of a subject within an imaging region and a selection unit selecting some inspection attributes from said plurality of inspection attributes displayed on said display unit, the operational apparatus including an inspection activity ratio calculation unit for calculating an activity ratio of each of the inspection attributes selected by said selection unit from said plurality of inspection attributes, said display unit displaying said plurality of inspection attributes differently in appearance, depending on the activity ratio of each inspection attribute calculated by said inspection activity ratio calculation unit.

According to the invention, it is possible to provide an imaging diagnosis system and its operational apparatus providing better operability and higher efficiency of imaging operation.

Further objects and advantages of the present invention will be apparent from the following description of the preferred embodiments of the invention as illustrated in the accompanying drawings.

### BRIEF DESCRIPTION OF THE DRAWINGS

FIG. 1 is an overall block diagram showing primary components of an imaging diagnosis system 200 in an embodiment of the invention.

FIG. 2 is a structural diagram showing the structure of a magnetic resonance imaging apparatus 1 in an embodiment of the invention.

FIG. 3 is a flowchart illustrating an operation of calculating the activity ratios of inspection attributes by the imaging diagnosis system 200 in an embodiment of the invention.

FIG. 4 is a flowchart illustrating an operation of capturing images of a subject within an imaging region by the imaging diagnosis system 200 in an embodiment of the invention.

FIG. 5 is a diagram showing a primary part of a display screen in which a plurality of inspection attributes are displayed by a display unit 33.

### DETAILED DESCRIPTION OF THE INVENTION

In the following, an exemplary embodiment of the invention will be described with reference to the drawings.

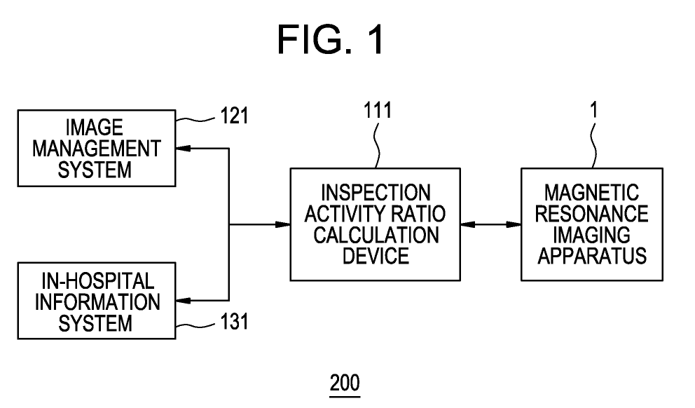

FIG. 1 is an overall block diagram showing primary components of an imaging diagnosis system 200 in an embodiment of the invention.

As shown in FIG. 1, the imaging diagnosis system 200 comprises a magnetic resonance imaging apparatus 1, an inspection activity ratio calculation device 111, an image management system 121, and an in-hospital information system 131, and the system is built in a hospital, for example. In the imaging diagnosis system 200, the magnetic resonance imaging apparatus 1 and the inspection activity ratio calculation device 111 are connected as shown in FIG. 1. Also, the activity ratio calculation device 111 and the image management system 121 are connected and the activity ratio calculation device 111 and the in-hospital information system 131 are connected. That is, the activity ratio calculation device 111, the image management system 121, and the in-hospital information system 131 are interconnected to form a network.

The magnetic resonance imaging apparatus 1 as a component of the imaging diagnosis system 200 is described.

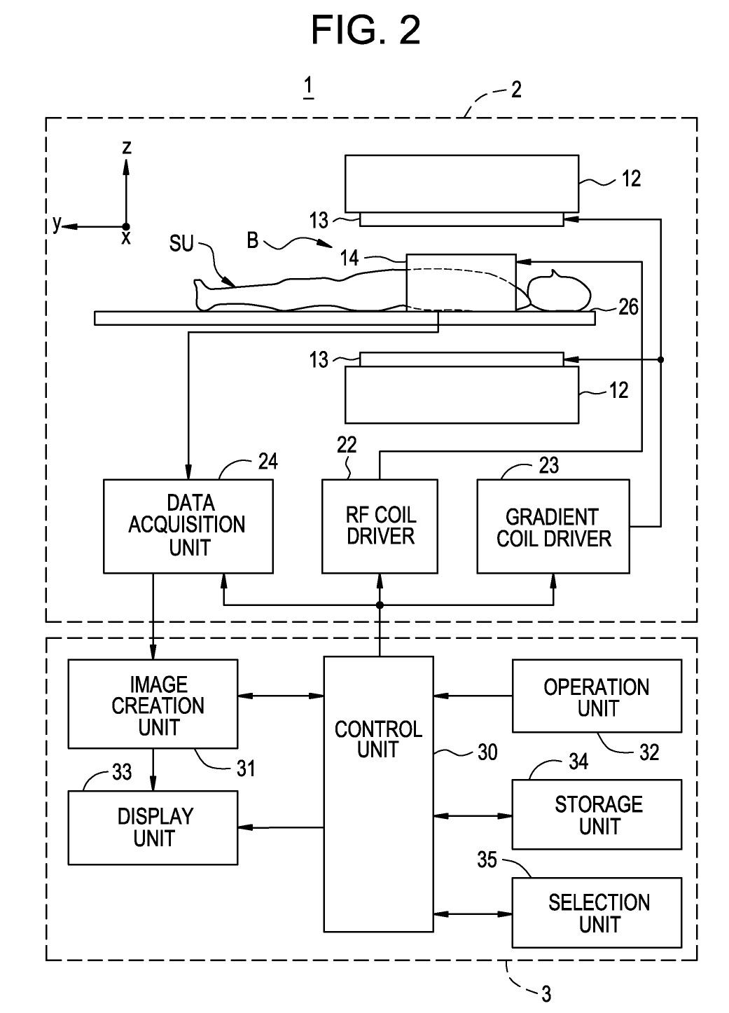

FIG. 2 is a structural diagram showing the structure of the magnetic resonance imaging apparatus 1 in an embodiment of the invention.

As shown in FIG. 2, the magnetic resonance imaging apparatus 1 comprises a scanning unit 2 and an operation console 3, and is installed, for example, in an image capturing room in a hospital. In this embodiment, the magnetic resonance imaging apparatus 1 captures images of a subject SU within an imaging region in accordance with inspection attributes selected by a selection unit 35, a component of the operation console 3, which will be described later in further detail.

The scanning unit 2 is outlined.

The scanning unit 2, as shown in FIG. 2, comprises static magnetic field generating magnet assemblies 12, gradient coil assemblies 13, an RF coil assembly 14, an RF coil driver 22, a gradient coil driver 23, a data acquisition unit 24, and a cradle 26, and performs scanning to acquire magnetic resonance signals as raw data from the subject SU within an imaging space B where a static magnetic field is formed.

The components of the scanning unit 2 are described one by one.

The static magnetic field generating magnet assemblies 12 include, for example, superconductive magnets disposed so as to sandwich the imaging space B in which the subject SU lies and the superconductive magnets form a static magnetic field in the imaging space B. Herein, the static magnetic field generating magnet assemblies 12 form the static magnetic field so that the direction of the static magnetic field aligns with a direction Z along the axial direction of the body of the subject SU. The static magnetic field generating magnet assemblies 12 may consist of permanent magnets.

The gradient coil assemblies 13 form gradient magnetic fields in the imaging space where the static magnetic field is formed to add positional information to magnetic resonance signals which the RF coil assembly 14 receives. Herein, the gradient coil assemblies 13 consist of three systems and form gradient magnetic fields in a frequency encoding direction, in a phase encoding direction, and in a slice selection direction, respectively, according to imaging conditions. In particular, the gradient coil assemblies 13 apply a gradient magnetic field in a slice selection direction of the subject SU and the RF coil assembly 14 sends RF pulses; thereby, a slice of the subject SU, which is excited, is selected. Also, the gradient coil assemblies 13 apply a gradient magnetic field in a phase encoding direction of the subject SU and phase encode the magnetic resonance signal from the slice excited by the RF pulses. Besides, the gradient coil assemblies 13 apply a gradient magnetic field in a frequency encoding direction of the subject SU and frequency encode the magnetic resonance signal from the slice excited by the RF pulses.

The RF coil assembly 14 is placed to enclose the imaging region of the subject SU, as shown in FIG. 2. The RF coil assembly 14 sends RF pulses of electromagnetic waves to the subject SU and forms a radio-frequency magnetic field within the imaging space where the static magnetic field is formed by the static magnetic field generating magnet assemblies 12 and thus excites spins of protons in the imaging region of the subject SU. Then, the RF coil assembly 23 receives electromagnetic waves generated from the excited protons inside the subject SU as magnetic resonance signals.

The RF coil driver 22 drives the RF coil assembly 14 to send RF pulses to within the imaging space B, thus forming the RF magnetic field. According to a control signal from the control unit 30, the RF driver 22 modulates a signal from an RF oscillator into a signal with a predefined timing and a predefined envelope by using a gate modulator; then, the signal modulated by the gate modulator is amplified by an RF power amplifier and output to the RF coil assembly 14 to cause the RF coil to send RF pulses.

According to a control signal from the control unit 30, the gradient coil driver 23 applies gradient pulses to the gradient coil assemblies 13 and drives them to generate a gradient magnetic field within the imaging space B where a static magnetic field is formed. The gradient coil driver 23 has three systems of dive circuits (not shown) dedicated to the three systems of the gradient coil assembles 13.

According to a control signal from the control unit 30, the data acquisition unit 24 acquires magnetic resonance signals received by the RF coil assembly 14 and outputs them to an image creation unit 31. The data acquisition unit 24 acquires phase encoded and frequency encoded magnetic resonance signals for k spaces. Herein, in the data acquisition unit 24, a phase detector detects the phase of magnetic resonance signals received by the RF coil assembly 14, using the output of the RF oscillator in the RF coil driver 11 as a reference signal. After that, the magnetic resonance signals that are analog signals are converted into digital signals by an A/D converter. Then, the data acquisition unit 24 stores the magnetic resonance signals into a memory and outputs them to the image creation unit 31.

The cradle 26 serves as a platform on which the subject SU is rested. The cradle 26 moves in the imaging space B and moves out therefrom, according to a control signal from the control unit 30.

The operation console 3 is outlined.

The operation console 3, as shown in FIG. 2, comprises the control unit 30, the image creation unit 31, an operation unit 32, a display unit 33, a storage unit 34, and a selection unit 35.

The components of the operation console 3 are described one by one.

The control unit 30 comprises a computer and a memory storing a program causing the components to perform operations related to a given scan, using the computer, and takes input of operational data from the operation unit 32. According to operational data input from the operation unit 32, the control unit 30 outputs control signals for executing a given scan to the RF coil driver 22, the gradient coil driver 23, and the data acquisition unit 24, respectively, and controls them. According to operational data input from the operation unit 32, the control unit 30 outputs control signals to the image creation unit, the display unit 33, and the storage unit and controls them. In this embodiment, the control unit 30 sets an inspection protocol in accordance with inspection attributes selected by the selection unit 35 and controls the components by the set protocol to execute capturing images of a subject SU within the imaging region.

The image creation unit 31 comprises a computer and a memory storing a program causing the computer to perform predefined data processing, receives magnetic resonance signals acquired by the data acquisition unit 24, performs image processing on the acquired magnetic resonance signals, and generates images with respect to a slice of the subject SU, according to a control signal from the control unit 30. The image creation unit 31 outputs the generated image to the display unit 33.

The operation unit 32 consists of operating devices such as a keyboard, a pointing device, etc. The operation unit 32 takes input operational data entered by the operator and outputs the operational data to the control unit 30. In this embodiment, a command to select some inspection attributes from a plurality of inspection attributes displayed on the display unit 33 is input by the operator, which will be described later in further detail.

The display unit 33 consists of a display device such as CRT and displays images on the display screen, according to a control signal from the control unit 30. For example, the display unit 33 receives from the image creation unit 31 data on a slice image of the subject SU created based on the magnetic resonance signals from the subject SU and displays the slice image on the display screen. Besides, the display unit 33 displays a plurality of inspection attributes when capturing images of a subject SU within an imaging region, which will be detailed later. Herein, the display unit 33 displays the plurality of inspection attributes differently in appearance, depending on the activity ratio of each inspection attribute calculated by the inspection activity ratio calculation device 111. In particular, based on inspection data stored in the image management system 121 consisting of records, each associating an inspection request with inspection attributes selected by the selection unit 35 from a plurality of inspection attributes when the inspection request was input, the display unit 33 displays the inspection attributes selected by the selection unit 35 when the inspection request was input. In this embodiment, the display unit 33 displays the inspection attributes in character strings. For example, the display unit 33 displays the character strings corresponding to the inspection attributes in different font sizes, depending on the activity ratio of each inspection attribute calculated by the inspection activity ratio calculation device 111. The display unit 33 displays the character strings corresponding to the inspection attributes in different colors, depending on the activity ratio of each inspection attribute calculated by the inspection activity ratio calculation device 111. For example, it displays the character strings with varying brightness.

The storage unit 34 consists of a memory and stores various kinds of data. Data stored in the storage unit 34 is accessed, when needed, by the control unit 30.

The selection unit 35 comprises a computer and a memory storing a program causing the computer to perform predefined operations and selects some inspection attributes from a plurality of inspection attributes displayed on the display unit 33. In this embodiment, the selection unit 35 selects inspection attributes according to a command entered via the operation unit 32 by the operator.

The inspection activity ratio calculation device 111, a component of the imaging diagnosis system 200, is described.

The inspection activity ratio calculation device 111 comprises a computer and a memory storing a program causing the computer to predefined operations and various kinds of data, is installed, for example, in a computer room in a hospital, and calculates the activity ratio of each inspection attribute selected from a plurality of inspection attributes by the selection unit 35. In this embodiment, the inspection activity ratio calculation device 111 receives from the image management system 121, inspection data consisting of records, each associating an inspection request input to the in-hospital information system 131 with inspection attributes selected by the selection unit 35 from a plurality of inspection attributes when the inspection request was input, and sorts the inspection attributes selected for each inspection request as an inspection protocol; this operation will be described later in further detail. Then, the calculation device calculates for each of the inspection attributes sorted as the inspection protocol the activity ratio at which the attribute has been selected. In other words, the calculation device calculates for each of the inspection attributes the frequency at which the attribute has been selected. The inspection activity ratio calculation device 111 executes the above calculation operation at a predetermined timing. For example, during a period after the end of hospital service hours and before the restart of its service, the calculation device executes the above calculation operation and stores results of inspection activity ratio calculations as data. When a doctor inputs an inspection request to the in-hospital information system 131, the calculation device outputs the results of inspection activity ratio calculations for inspection attributes associated with the inspection request to the magnetic resonance imaging apparatus 1.

The image management system 121, a component of the imaging diagnosis system 200, is described.

The image management system 121 is a Picture Archiving and Communication System (PACS), includes a storage device, and stores information on captured images as data. In this embodiment, the image management system 121 stores inspection data consisting of records, each associating an inspection request stored in the in-hospital information system 131 with inspection attributes selected by the selection unit 35 from a plurality of inspection attributes when the inspection request was input.

The in-hospital information system 131, a component of the imaging diagnosis system 200, is described.

The in-hospital information system 131 includes a storage device and stores inspection requests input by doctors with regard to an imaging region of a subject and information on imaging diagnosis results as data. The in-hospital information system 131 is connected to the inspection activity ratio calculation device 111 and outputs data of an inspection request input to it to the inspection activity ratio calculation device 111.

In the following, operations of the imaging diagnosis system 200 are described in an embodiment of the invention described above.

An operation of calculating the activity ratios of inspection attribute is described.

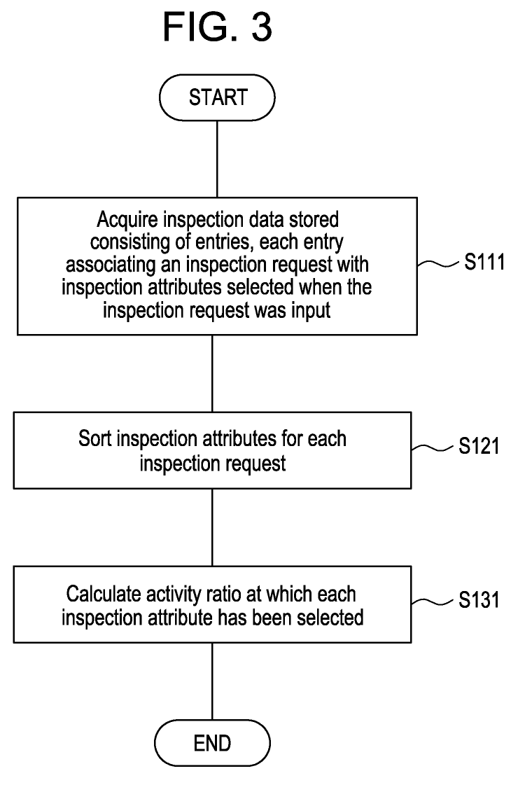

FIG. 3 is a flowchart illustrating the operation of calculating the activity ratios of inspection attributes by the imaging diagnosis system 200 in an embodiment of the invention.

A first step, as shown in FIG. 3, is to acquire inspection data stored consisting of records, each associating an inspection request with inspection attributes selected when the inspection request was input (ST111).

Herein, as described above, the inspection activity ratio calculation device 111 receives from the image management system 121 the inspection data stored in the image management system 121 consisting of records, each associating an inspection request input by a doctor and stored in the in-hospital information system 131 with inspection attributes selected by the selection unit 35 from a plurality of inspection attributes, according to a command from the operator.

For example, the calculation device acquires inspection data including records associating an inspection request “brain cancer suspected” with a plurality of inspection attributes “Localizer”, “T1 Axial”, “T2 Axial”, “FLAIR Axial”, “DTI”, “MRS single voxel”, “PWI”, and “CE T1 Axial” selected when the same inspection request was issued. That is, the calculation device receives, as inspection data, a set of records on inspection requests issued by sections in the hospital; in each record, a request is associated with inspection attributes selected and executed in accordance with the request.

In the foregoing, “Localizer” is an inspection attribute that is executed to position an imaging region of a subject. “T1 Axial” is an inspection attribute to obtain a T1-enhanced image on the axial plane in the imaging region; “T2 Axial” is an inspection attribute to obtain a T2-enhanced image on the axial plane in the imaging region; and “FLAIR Axial” is an inspection attribute to obtain a FLAIR (Fluid Attenuated Inversion Recovery) image on the axial plane in the imaging region. “DTI” is an inspection attribute to obtains a DTI (Diffusion Tensor Imaging) image and “MRS single voxel” is an inspection attribute to obtain MRS (MR Spectoscopy) data for a single voxel. “PWI” is an inspection attribute to obtain a PWI (Perfusion Weighted Imaging) image and “CE T1 Axial” is an inspection attribute to obtain a CE (Contrast Enhanced) T1-enhanced image on the axial plane in the imaging region.

A next step, as shown in FIG. 3, is to sort the inspection attributes selected for each inspection request (S121).

Herein, the inspection activity ratio calculation device 111 sorts the inspection data received from the image management system 121 for each inspection request, as described above.

For example, with regard to the inspection request “brain cancer suspected”, from the records on the inspection attributes “Localizer”, “T1 Axial”, “T2 Axial”, “FLAIR Axial”, “DTI”, “MRS single voxel”, “PWI”, and “CE T1 Axial” selected whenever the same inspection request was issued, the calculation device counts up and extracts the number of times each attribute has been selected and sorts and stores these attributes as an inspection protocol.

A next step, as shown in FIG. 3, is to calculate the activity ratio at which each inspection attribute has been selected (S131).

Herein, for each of the inspection attributes sorted for each inspection request, the inspection activity ratio calculation device 111 calculates the activity ratio at which each attribute has been selected.

In particular, with regard to the inspection request “brain cancer suspected”, after the inspection attributes “Localizer”, “T1 Axial”, “T2 Axial”, “FLAIR Axial”, “DTI”, “MRS single voxel”, “PWI”, and “CE T1 Axial” are sorted, the calculation device calculates the activity ratio by calculating a ratio of the number of times each attribute has been selected to a total number of times the inspection request “brain cancer suspected” has been issued. For example, the calculations indicate that the inspection attributes “Localizer”, “T1 Axial”, “T2 Axial”, “FLAIR Axial”, and “CE T1 Axial” have a high activity ratio, the inspection attributes “DTI” and “PWI” have an intermediate activity ratio, and the inspection attribute “MRS single voxel” has a low activity ratio. In this embodiment, this calculation operation is carried out at a predetermined timing. For example, during the nighttime between the end of hospital service hours and the restart of the service, the calculation device executes the above calculation operation and stores calculation results as data.

An operation of capturing images of a subject within an imaging region is described.

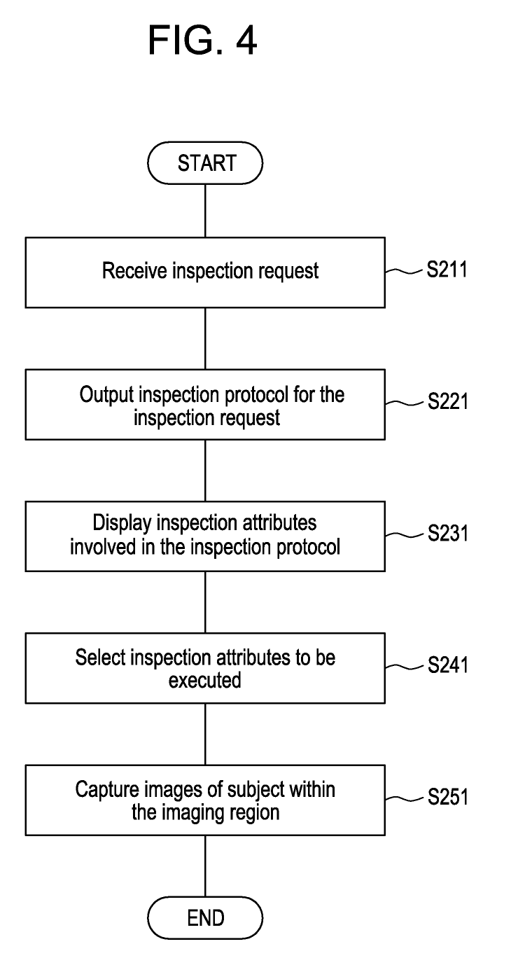

FIG. 4 is a flowchart illustrating an operation of capturing images of a subject within an imaging region by the imaging diagnosis system 200 in an embodiment of the invention.

A first step, as shown in FIG. 4, is to receive an inspection request (ST211).

Herein, the inspection activity ratio calculation device 111 receives from the in-hospital information system 131 an inspection request input by a doctor to the in-hospital information system 131.

For example, the calculation device receives an inspection request “brain cancer suspected”.

A next step, as shown in FIG. 4, is to output an inspection protocol for the inspection request (ST221).

Herein, the inspection activity ratio calculation device 111 outputs an inspection protocol, in which the inspection attributes selected for each inspection request were sorted, to the operation console 3 of the magnetic resonance imaging apparatus 1.

A next step, as shown in FIG. 4, is to display a plurality of inspection attributes in the inspection protocol (ST231).

Herein, the display unit 33 of the operation console 3 displays a plurality of inspection attributes for capturing images of a subject SU within an imaging region, involved in the inspection protocol output by the inspection activity ratio calculation device 111.

In this embodiment, the display unit 33 displays the inspection attributes differently in appearance, depending on the activity ratio of each inspection attribute calculated by the inspection activity ratio calculation device 111.

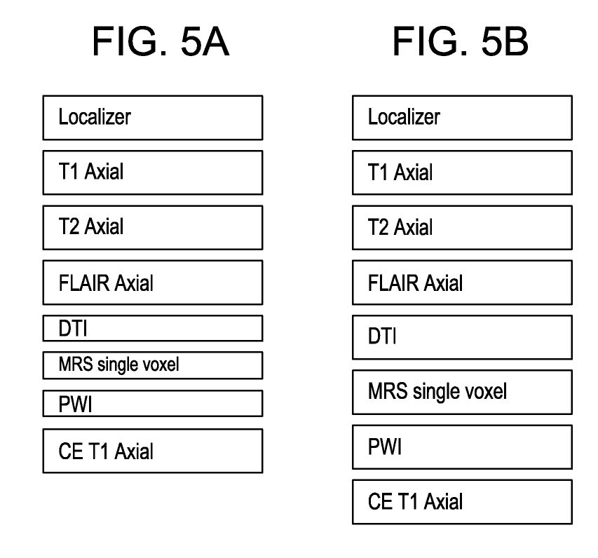

FIG. 5 is a diagram showing a primary part of a display screen in which a plurality of inspection attributes are displayed by the display unit 33.

As shown in FIG. 5(a), the display unit 33 displays the inspection attributes in character strings. For example, buttons in which the character strings corresponding to the inspection attributes are enclosed, respectively, are displayed on the display screen in different font sizes, depending on the activity ratio of each inspection attribute calculated by the inspection activity ratio calculation device 111.

In particular, in the inspection protocol for the inspection request “brain cancer suspected”, as indicated above, if it was calculated that the inspection attributes “Localizer”, “T1 Axial”, “T2 Axial”, “FLAIR Axial”, and “CE T1 Axial” have a high activity ratio, the inspection attributes “DTI” and “PWI” have a intermediate activity ratio, and the inspection attribute “MRS single voxel” has a low activity ratio, the inspection attributes “Localizer”, “T1 Axial”, “T2 Axial”, “FLAIR Axial”, and “CE T1 Axial” are displayed in a large font, the inspection attributes “DTI” and “PWI” are displayed in a medium font, and the inspection attribute “MRS single voxel” is displayed in a small font correspondingly to the calculation results, as shown in FIG. 5(a).

As shown in FIG. 5(b), the character strings corresponding to the inspection attributes may be shown in different colors, depending on the activity ratio of each inspection attribute calculated by the inspection activity ratio calculation device 111. Accordingly, for example, the character strings with varying brightness are displayed.

In particular, as shown in FIG. 5(a), the inspection attributes “Localizer”, “T1 Axial”, “T2 Axial”, “FLAIR Axial”, and “CE T1 Axial” are displayed in a color with a higher color density, the inspection attributes “DTI” and “PWI” are displayed in a color with a medium color density, and the inspection attribute “MRS single voxel” is displayed in a color with a low color density.

A next step, as shown in FIG. 4, is to select inspection attributes to be executed (ST241).

Herein, after a command selecting some inspection attributes from the plurality of inspection attributes displayed on the display unit 33 is input by the operator, the selection unit 35 selects the inspection attributes in accordance with the command input via the operation unit 32 by the operator.

For example, in the case of the inspection request “brain cancer suspected”, when the operator points coordinate positions on the display screen using a pointing device to select the buttons of “Localizer”, “T1 Axial”, “T2 Axial”, “FLAIR Axial”, and “CE T1 Axial” as show in FIG. 5, which have been executed at a high activity ratio, these attributes are selected correspondingly.

As described above, the image management system 121 stores the attributes selected here, associated with the inspection request stored in the in-hospital information 131, as additional data to the inspection data. Subsequently, the inspection activity ratio is calculated based on the updated inspection data.

A next step, as shown in FIG. 4, is to capture images of a subject within the imaging region (ST251).

Herein, the operator inputs operational data to start a scan, for example, by clicking a scan start button using the pointing device of the operation unit 32, and the scanning unit 2 performs a scan in accordance with the selected inspection attributes. By this scan, magnetic resonance signals from the subject SU within the imaging space B where a static magnetic field is formed are acquired as raw data. Then, based the magnetic resonance signals acquired by the scan, the image creation unit 31 creates images of the subject SU in accordance with the inspection attributes.

As described above, in this embodiment, the display unit 33 displays the plurality of inspection attributes differently in appearance, depending on the activity ratio of each inspection attribute calculated by the inspection activity ratio calculation device 111. Herein, for example, the character strings corresponding to the inspection attributes are displayed in different font sizes or different colors, depending on the activity ratio of each inspection attribute calculated by the inspection activity ratio calculation device 111. Thus, the present embodiment enables an operator, even an unskilled operator, to make a decision and perform input operation efficiently when selecting inspection attributes to be executed and, consequently, can improve the efficiency of imaging operation when capturing images of a subject.

In this embodiment, the inspection activity ratio calculation device 111 executes the operation of calculating the activity ratio at a predetermined timing. For example, during a period after the end of medical service hours and before the start thereof, the calculation unit executes this calculation operation and stores the calculation results of the inspection activity ratio as data. Thus, the present embodiment data enables processing and displaying a plurality of inspection attributes on the display unit 33 in an efficient manner, as noted above, and, therefore, can improve the efficiency of imaging operation when capturing images of a subject.

The magnetic resonance imaging apparatus 1 in the foregoing embodiment corresponds to an image capturing unit in the invention. The scanning unit 2 in the foregoing embodiment corresponds to a scanning unit in the invention. The operation console 3 in the foregoing embodiment corresponds to an operational apparatus of the invention. The image generation unit 31 in the foregoing embodiment corresponds to an image creation unit in the invention. The operation unit 32 in the foregoing embodiment corresponds to a select command input unit in the invention. The display unit 33 in the foregoing embodiment corresponds to a display unit in the invention. The storage unit 34 in the foregoing embodiment corresponds to a storage unit in the invention. The selection unit 35 in the foregoing embodiment corresponds to a selection unit in the invention. The inspection activity ratio calculation device 111 in the foregoing embodiment corresponds to an inspection activity ratio calculation unit in the invention. The in-hospital information system 131 in the foregoing embodiment corresponds to an inspection request input unit in the invention. The imaging diagnosis system 200 in the foregoing embodiment corresponds to an image diagnosis system of the invention.

The invention can be implemented in various forms of modifications, not limited to the foregoing embodiment.

For example, when displaying inspection attributes on the display in the foregoing embodiment, additionally, some of the attributes may be highlighted by adding ornamental letters.

While the foregoing embodiment illustrates the invention, for example, in a situation where images are captured by the magnetic resonance imaging apparatus; the scope of the invention is not limited to MRI. The invention can be applied to, for example, X-ray CT apparatus and the like.

While the foregoing embodiment illustrates the invention using an example of an inspection request “brain cancer suspected”; the scope of the invention is not so limited. The scope of the invention can be extended to a molecular imaging inspection protocol, if gene information of a subject is loaded into the inventive system.

Many widely different embodiments of the invention may be configured without departing from the spirit and the scope of the present invention. It should be understood that the present invention is not limited to the specific embodiments described in the specification, except as defined in the appended claims.

1. An imaging diagnosis system comprising a display unit displaying a plurality of inspection attributes for capturing images of a subject within an imaging region, a selection unit selecting some inspection attributes from said plurality of inspection attributes displayed on said display unit, and an image capturing unit capturing the images within said imaging region in accordance with the inspection attributes selected by said selection unit,
the imaging diagnosis system including an inspection activity ratio calculation unit for calculating an activity ratio of each of the inspection attributes selected by said selection unit from said plurality of inspection attributes,
said display unit displaying said plurality of inspection attributes differently in appearance, depending on the activity ratio of each inspection attribute calculated by said inspection activity ratio calculation unit.

2. The imaging diagnosis system according to claim 1, including:
a select command input unit via which a command selecting attributes from said plurality of inspection attributes displayed on said display unit is input by an operator,
wherein said selection unit selects said inspection attributes according to a command input via said select command input unit.

3. The imaging diagnosis system according to claim 1, including:
an inspection request input unit to which an inspection request regarding said imaging region is input;
a storage unit storing inspection data consisting of records, each associating said inspection request input to said inspection request input unit with said inspection attributes selected by said selection unit from said plurality of inspection attributes when the inspection request was input,
wherein said display unit displays said inspection attributes selected by said selection unit from said plurality of inspection attributes when said inspection request was input, based on said inspection data stored on said storage unit.

4. The imaging diagnosis system according to claim 1, wherein said image capturing unit includes:
a scanning unit scanning said imaging region to acquire raw data; and
an image creation unit creating images of the subject within said imaging region, based on the raw data acquired by said scanning unit.

5. The imaging diagnosis system according to claim 4, wherein:
said scanning unit performs a scan to acquire magnetic resonance signals produced in said imaging region in a static magnetic space as said raw data; and
said image creation unit creates images of said subject, based on said magnetic resonance signals acquired by said scanning unit.

6. The imaging diagnosis system according to claim 1, wherein said display unit displays said plurality of inspection attributes in character strings.

7. The imaging diagnosis system according to claim 6, wherein said display unit displays the character strings corresponding to said plurality of inspection attributes in different font sizes, depending on the activity ratio of each inspection attribute calculated by said inspection activity ratio calculation unit.

8. The imaging diagnosis system according to claim 6, wherein said display unit displays the character strings corresponding to said plurality of inspection attributes in different colors, depending on the activity ratio of each inspection attribute calculated by said inspection activity ratio calculation unit.

9. The imaging diagnosis system according to claim 8, wherein said display unit displays the character strings corresponding to said plurality of inspection attributes in different brightness levels, depending on the activity ratio of each inspection attribute calculated by said inspection activity ratio calculation unit.

10. The imaging diagnosis system according to claim 1, wherein said inspection activity ratio calculation unit executes an operation of calculating said activity ratio at a predetermined timing.

11. An operational apparatus comprising a display unit displaying a plurality of inspection attributes for capturing images of a subject within an imaging region and a selection unit selecting some inspection attributes from said plurality of inspection attributes displayed on said display unit,
the operational apparatus including an inspection activity ratio calculation unit for calculating an activity ratio of each of the inspection attributes selected by said selection unit from said plurality of inspection attributes,
said display unit displaying said plurality of inspection attributes differently in appearance, depending on the activity ratio of each inspection attribute calculated by said inspection activity ratio calculation unit.

12. The operational apparatus according to claim 11, including:
a select command input unit via which a command selecting attributes from said plurality of inspection attributes displayed on said display unit is input by an operator,
wherein said selection unit selects said inspection attributes according to a command input via said select command input unit.

13. The operational apparatus according to claim 11, including:
an inspection request input unit to which an inspection request regarding said imaging region is input;
a storage unit storing inspection data consisting of records, each associating said inspection request input to said inspection request input unit with said inspection attributes selected by said selection unit from said plurality of inspection attributes when the inspection request was input,
wherein said display unit displays said inspection attributes selected by said selection unit from said plurality of inspection attributes when said inspection request was input, based on said inspection data stored on said storage unit.

14. The operational apparatus according to claim 12, including:
an inspection request input unit to which an inspection request regarding said imaging region is input;
a storage unit storing inspection data consisting of records, each associating said inspection request input to said inspection request input unit with said inspection attributes selected by said selection unit from said plurality of inspection attributes when the inspection request was input,
wherein said display unit displays said inspection attributes selected by said selection unit from said plurality of inspection attributes when said inspection request was input, based on said inspection data stored on said storage unit.

15. The operational apparatus according to claim 11, wherein said display unit displays said plurality of inspection attributes in character strings.

16. The operational apparatus according to claim 12, wherein said display unit displays said plurality of inspection attributes in character strings.

17. The operational apparatus according to claim 15, wherein said display unit displays the character strings corresponding to said plurality of inspection attributes in different font sizes, depending on the activity ratio of each inspection attribute calculated by said inspection activity ratio calculation unit.

18. The operational apparatus according to claim 15, wherein said display unit displays the character strings corresponding to said plurality of inspection attributes in different font colors, depending on the activity ratio of each inspection attribute calculated by said inspection activity ratio calculation unit.

19. The operational apparatus according to claim 18, wherein said display unit displays the character strings corresponding to said plurality of inspection attributes in different brightness levels, depending on the activity ratio of each inspection attribute calculated by said inspection activity ratio calculation unit.

20. The operational apparatus according to claim 11, wherein said inspection activity ratio calculation unit executes an operation of calculating said activity ratio at a predetermined timing.
